(19) United States
(12) Patent Application Publication
(10) Pub. No.: US 2010/0070890 A1
(43) Pub. Date: Mar. 18, 2010

(54) Method for Providing a Manufacturing Execution System (MES) Service to Third Parties

(75) Inventors: Jakob Axt, Saulheim (DE); Christian Becker, Bruchweiler (DE); Hans-Juergen Eickelmann, Nieder-Hilbersheim (DE); Rainer Kaus Krause, Kostheim (DE); Thorsten Muehge, Budenheim (DE); Ralph Schoenhofer, Saulheim (DE)

Correspondence Address: KING & SPALDING, 1180 PEACHTREE ST., ATLANTA, GA, 30309, US

(73) Assignee: International Business Machines Corporation, Armonk, NY (US)

(21) Appl. No.: 12/209,870

(22) Filed: Sep. 12, 2008

(51) Int. Cl. G06F 3/048

(52) U.S. Cl. 715/762

(57) ABSTRACT

A computer-implemented method for providing on-demand manufacturing execution systems for clients in which a response to a questionnaire from a client with information relative to identification of a business and production process, a determination of process steps, and an identification of process step requirements is evaluated by the service provider according to GUI requirements for each one of a number of individual process steps. Based on the evaluation, a GUI is defined for each of the individual process steps by the service provider and provided to the client for installation on client computing devices in a manufacturing line of the client. Data is collected for each of the individual process steps via each GUI and sent to the service provider for storage and evaluation.

### BACKGROUND OF THE INVENTION

1. Field of the Invention

This invention relates to manufacturing execution systems (MES) and more particularly to methods for providing on-demand MES for small and medium businesses, based on an elementary structure, a low cost and a high level of efficiency.

2. Description of Background

MES systems are computerized systems used by manufacturers in real time managing and controlling of their entire manufacturing processes. Presently, small companies cannot afford to use MES systems because the cost of customization of such MES systems is simply too great, and there is currently no basic MES available for small companies. As used herein the term “small company” is defined as having a process in place with less than ten process steps. Small companies with low revenue of $1,000,000 or less and non high tech applications generally have problems in generating electronic data within their processes. A customized MES is relatively expensive, and for most small companies such customized MES is simply not affordable. There is presently a need for basic MES which can easily be customized per process step and implemented with minimal effort on the part of the business.

### SUMMARY OF THE INVENTION

The shortcomings of the prior art are overcome and additional advantages are provided through embodiments of the invention proposing methods for providing on-demand MES for small and medium businesses. Embodiments of the invention propose a computer-implemented method for providing on-demand manufacturing execution systems for clients that involves, for example, receiving a response to a questionnaire from a client by a service provider via a global network, which response contains information from the client relative at least to an identification of a business and production process, a determination of process steps, and an identification of process step requirements.

According to embodiments of the invention, the response to the questionnaire is evaluated by the service provider according to graphical user interface requirements for each one of a number of individual process steps. Based on the evaluation, a graphical user interface is defined for each one of the individual process steps by the service provider and provided to the client for installation on client computing devices in a manufacturing line of the client via the global network according to pre-existing graphical user interface templates identified by the service provider or new graphical user interface templates generated by the service provider.

In embodiments of the invention, electronic data is received via the global network in real time by the service provider that was collected via the graphical user interface for each of the plurality of individual process steps within the client manufacturing line, the data containing information at least in part relative to process and equipment conditions and identification, process and product material and operational data, and maintenance and time stamp information. The received electronic data is uploaded by the service provider into a data repository and evaluated by the service provider for purposes of monitoring and controlling each of the plurality of individual process steps, and real time reports are generated to the client by the service provider based on the evaluation of the uploaded electronic data.

### Technical Effects

As a result of the summarized invention, technically we have achieved a solution for implementing methods for providing on-demand MES for small and medium businesses in which a provider provides a basic MES via the web that can easily be customized per process step and implemented with minimal effort on the part of a customer-business.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a flow chart that illustrates an example of the process of providing on-demand MES for embodiments of the invention;

FIG. 2 is a schematic diagram that illustrates an example of the basic architecture employed in embodiments of the invention;

FIG. 3 is a flow chart which illustrates an example of the flow of information between the customer and provider of the on-demand MES for embodiments of the invention;

FIG. 4 is a flow chart that illustrates an example of the installation process for embodiments of the invention;

FIG. 5 is a flow chart that illustrates an example of defined process steps and process flow for embodiments of the invention;

FIG. 6 is a table that illustrates examples of particular process steps defined for embodiments of the invention;

FIG. 7 is a table that illustrates examples of data structure for embodiments of the invention;

FIG. 8 illustrates an example of the internet questionnaire for embodiments of the invention;

FIG. 9 is a flow chart that illustrates an example of the process flow in using the on-demand MES for embodiments of the invention; and

FIG. 10 is a schematic diagram that illustrates an overview example of the service architecture for embodiments of the invention.

The detailed description explains the preferred embodiments of the invention, together with advantages and features, by way of example with reference to the drawings.

### DETAILED DESCRIPTION OF THE INVENTION

Embodiments of the invention propose a method for providing on-demand MES for small and medium businesses utilizing an elementary structure that affords a low cost at a high level of efficiency. According to embodiments of the invention, a provider, which is also the system owner and administrator, provides a basic MES that can easily be customized per process step and implemented with minimal effort on the part of the customer-business.

The MES configuration and download for embodiments of the invention is performed through the web. The basic MES covers basic MES requirements to secure process control and traceability. A generic data input tool (GDIT) design is the base platform for the GUI design for each individual process step for embodiments of the invention.

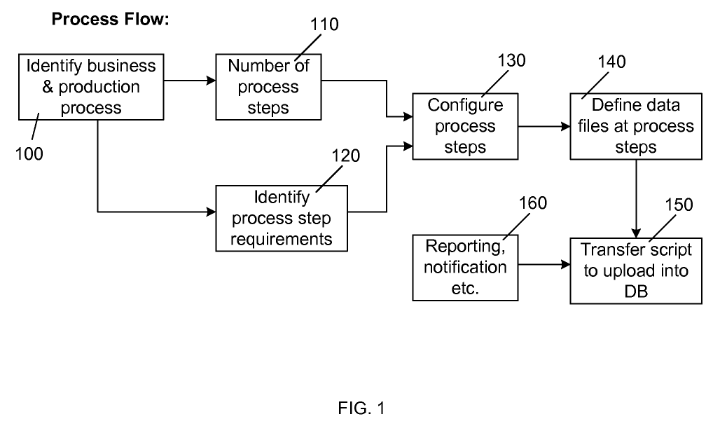

FIG. 1 is a flow chart that illustrates an example of the process of providing on-demand MES for embodiments of the invention. Referring to FIG. 1, at 100, the business and production process is identified; at 110, the number of process steps is determined, and at 120, the process step requirements are identified. Referring further to FIG. 1, at 130, the process steps are configured and at 140, data files are defined at the process steps. Referring again to FIG. 1, at 150, a script is transferred to upload into a database, and at 160, reporting, notification, etc. are performed.

The customer does not need a complex information technology (IT) structure to participate in the on-demand MES process for embodiments of the invention. On the contrary, it is only necessary for the customer to have internet access and computers available in its manufacturing line. The service provider has the entire IT structure to run the on-demand MES as well as to perform data uploads, data evaluations, alerts, notifications, reporting, and the like.

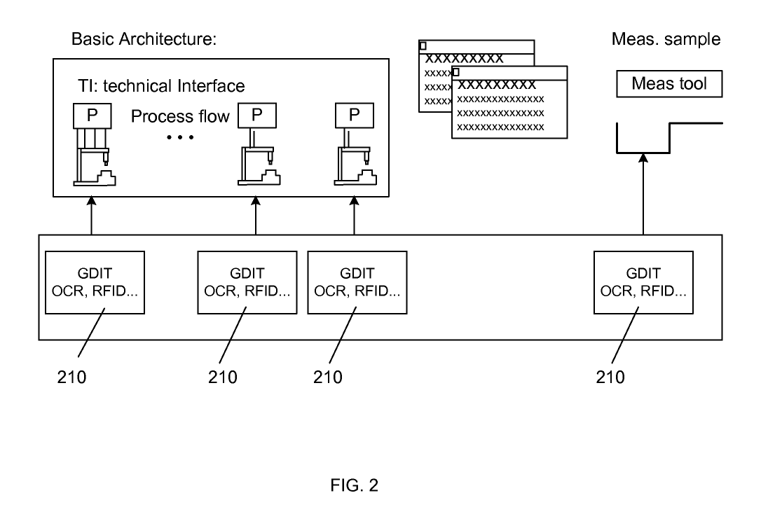

FIG. 2 is a schematic diagram that illustrates an example of the basic architecture employed in embodiments of the invention. Measurement data can be uploaded (serial port etc.) or dialed in manually. Material information, such as part, lot, serial numbers etc., is transferred at the process step via bar code reader, RFID reader, manually etc. The GUI for embodiments of the invention, also referred herein as the GDIT 210, is a specific design which enables the creation of a process step specific GUI. The time stamp is used from the synchronized system time.

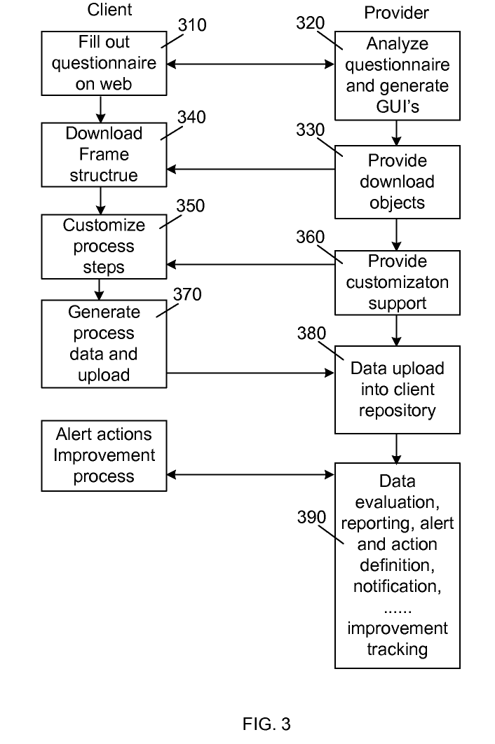

FIG. 3 is a flow chart which illustrates an example of the flow of information between the customer and provider of the on-demand MES for embodiments of the invention. Referring to FIG. 3, at 310, the customer receives via internet a questionnaire which the customer uses to describe the customer's process, step by step. At 320, the provider analyzes the questionnaire and determines whether or not existing templates for GUI's can be used or if new templates must be generated at 330. Based on this analysis, at 340, the client receives the GUI's to install on the computers in the manufacturing line. It can be one computer per process step or per several process steps. At 350, the GUI's, if needed, can now customized by the client or with provider support at 360, to fit the individual process step requirements.

With the installed GUI's the client now generate electronic data within the manufacturing per process step at 370. The data can contain information about the process and equipment conditions, as well as process step/equipment ID. Also, process and product material and operational data are collected. The data set certainly contains maintenance and time stamp information as well. The entire data set goes per process step and time unit to the service provider at 380. The service provider places the data into a data structure which enables customer dedicated evaluation and reporting at 390. Other services around the MES data, such as SPC, CpK, alert, notification, yield management, KPI definition etc. can be provided by the service provider as well.

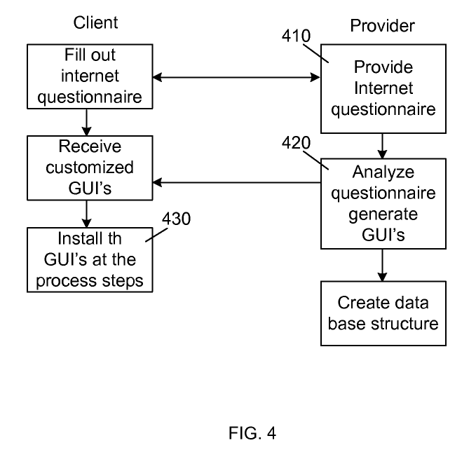

FIG. 4 is a flow chart that illustrates an example of the installation process for embodiments of the invention. Referring to FIG. 4, at 410, the service provider delivers the questionnaire which is used at 420 to analyze the customer's manufacturing process in terms of MES requirements. Based on the questionnaire feedback, a MES requirement matrix is defined and used to generate single process step GUIs at 430. These GUIs are the interfaces between the manufacturing level on the customer's side and the remote MES on the service provider's side. The GUIs are used to collect all necessary data at the process steps and send the data immediately to the service provider to maintain a real time approach.

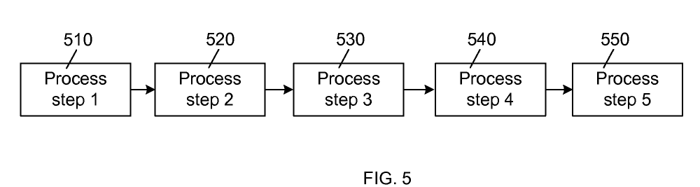

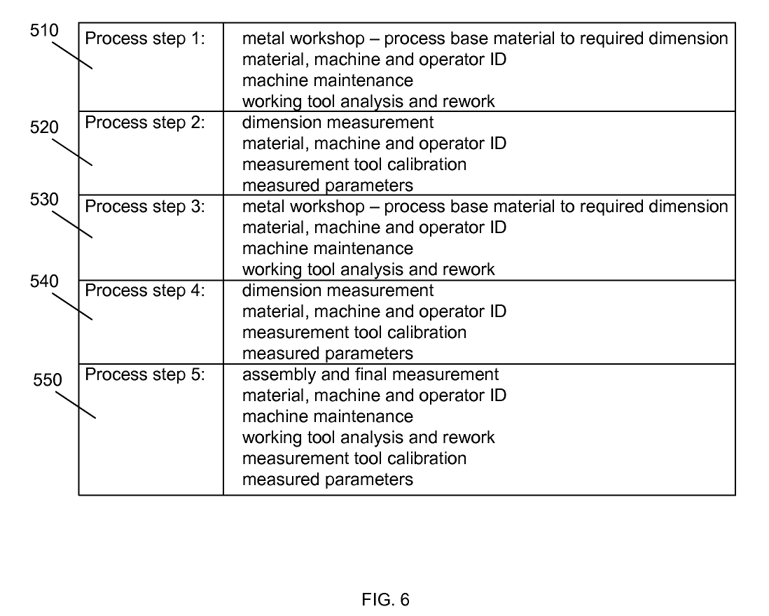

FIG. 5 is a flow chart that illustrates an example of defined process steps and process flow for embodiments of the invention. The example illustrated in FIG. 5, shows a process flow containing five process steps 510, 520, 530, 540, and 550. As outlined, the data structure at the service provider is based on the customer's requirements. This means that the data structure design and size is adapted automatically to the customer's MES requirements. FIG. 6 is a table that illustrates examples of particular process steps 510, 520, 530, 540, and 550 defined for embodiments of the invention.

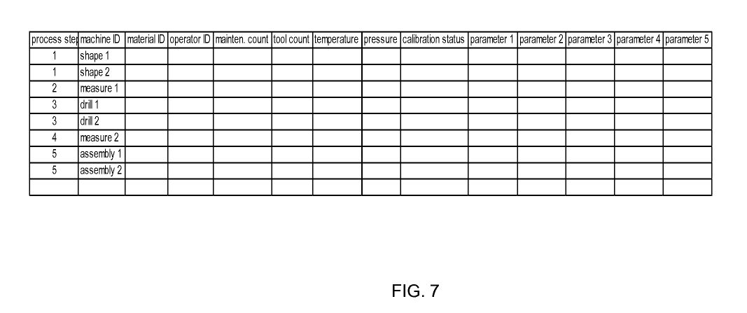

FIG. 7 is a table that illustrates an example of a data structure for embodiments of the invention. The exemplary data structure shown in FIG. 7 is a base data structure being used for the base data table design. Depending on the number of process steps and number of parameters used per process step the table structure is modified and optimized.

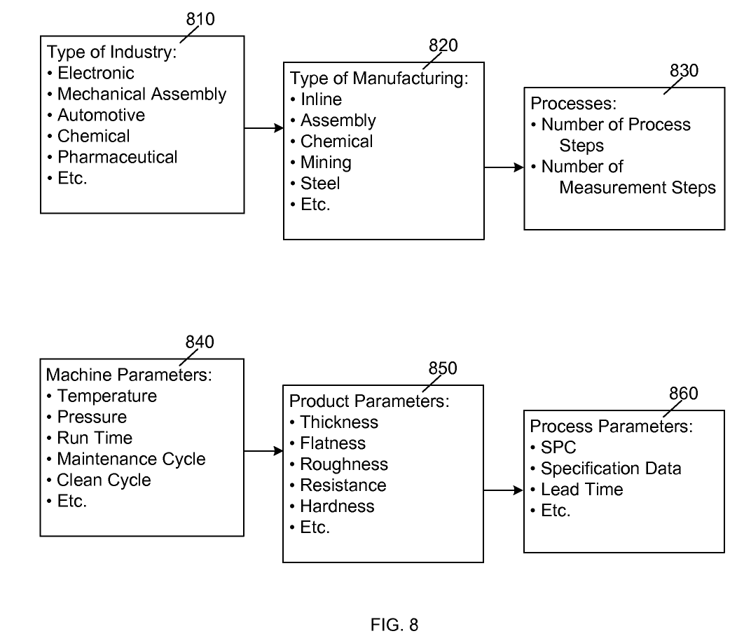

FIG. 8 illustrates an example of the internet questionnaire for embodiments of the invention. The questionnaire covers main industry 810, 820 and related process 830 and equipment requirements and parameters 840, 850 and 860. The questionnaire contains a base set of parameters used in the listed industries. In case new industries or parameters are insert the existing questionnaire template is extended and adapted accordingly.

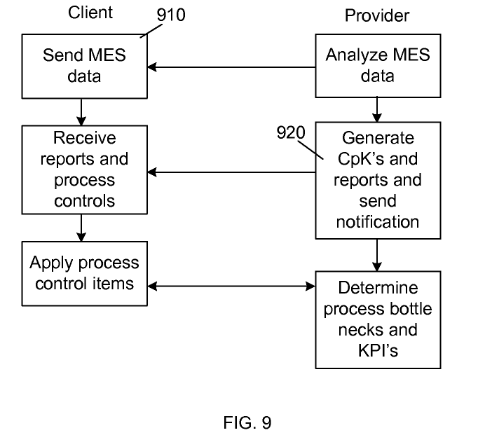

FIG. 9 is a flow chart that illustrates an example of the process flow in using the on-demand MES for embodiments of the invention. Referring to FIG. 9, the MES service content on the service provider's side starts with the data upload at 910 from the individual process step at the customer. Any base MES capable service can now be realized on the service provider side. The equipment and material/process control is the base, but also any type of advanced reporting and alert can be performed at 920 on the service provider's side.

The MES service contents for embodiments of the invention reflect process flow in the service system and advanced GDIT design which realizes MES-capable GUI per process step. The MES flow that is reflected in the service system includes all process and measurement steps installed, all parameters in the data base structure, SPC and controls installed, and inline specification limits installed.

The MES flow reflected in the service system also includes real time evaluation of data provided by the customer through the GUIs, standard reporting (mean, sigma and distributions), a real time alert and notification system, actual process capability measure (Cpk) and key performance indicator (KPI) determination and reporting, process and yield improvement reporting, dynamic adjustment of the MES setup, yield management capability and traceability capability using a time stamp.

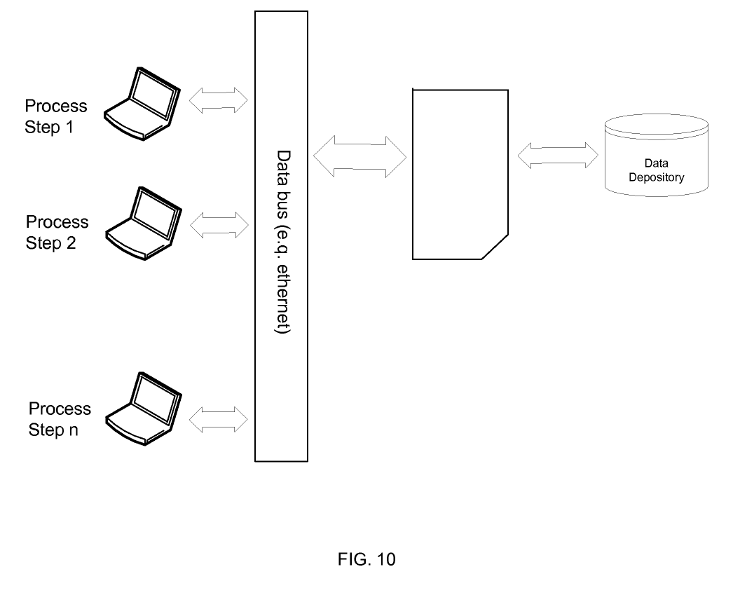

FIG. 10 is a schematic diagram that illustrates an overview example of the service architecture for embodiments of the invention.

An important aspect of embodiments of the invention is that the business/manufacturing process is not affected. The GDIT design employed is in a generic data format, is adaptive, and can be configured through text table entry for each process step. The installation approach is “bottom up” instead of “top down” as with standard systems. System and data administration is provided on demand through the GDIT functionality, and MES and traceability data are centrally stored and maintained.

Another important aspect of embodiments of the invention is simplicity. The MES function is provided at a low budget in which no interfaces or customization effort is required. It is easily scalable for more process steps and/or parameters and immediate usage is possible. Further, there is no IT system complexity and/or dependency involved and real time reporting is provided from a third party provider.

Embodiments of the invention involve, for example, downloading the MES frame architecture based on a questionnaire analysis and generating GUI's from GDIT based on process step requirements. The GUI is installed per process and measurement step or combined. The process step is easily configured using macros to customize according to process step requirements. A service provider's generic database is used to store all customized process data, and the client has access to the client's process data on the service database. The service provider also generates any reports required, as well as alert messages and data evaluations for process and quality improvement requirements based, for example, on KPI and Cpk evaluations and monitoring.

The on-demand MES system for embodiments of the invention is set up and configured via the web using a base questionnaire to configure individual process step GUI's. Embodiments of the invention propose a method for providing a MES service by a MES provider to third parties in which the MES provider provides an entire MES infrastructure including a data processing system for running the MES, a configurator for generating a GUI for each individual process step that is the interface to the MES process step, a data repository storing all process related input data coming from the GUIs, and in which the third party provides a data processing system with a communication link to the MES provider's data processing system.

The method for providing the MES service according to embodiments of the invention involves, for example, sending a questionnaire to define a GUI for each individual process step to the third party and receiving the filled out questionnaire from the third party. The questionnaire is evaluated according to GUI requirements for each individual process step, and existing GUI templates are identified or new GUI templates are generated based on the questionnaire. The identified or new GUI's are sent to the third party to be installed at the third party side.

Process step related data provided via the GUIs is received from the third party and uploaded into a data repository according to the process flow. The data is evaluated for process, monitor and control purposes, and real time reporting is generated to the third party on process requirements as defined on a GUI level, thus enabling alert and notification capability as part of the reporting.

The flow diagrams depicted herein are only examples. There may be many variations to these diagrams or the steps (or operations) described therein without departing from the spirit of the invention. For example, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A computer-implemented method for providing on-demand manufacturing execution systems for clients, comprising:
receiving a response to a questionnaire from a client by a first computer software application process tangibly embodied in a physical storage device executing on a physical computer hardware machine of a service provider over a global network, the response to the questionnaire containing information from the client relative at least to an identification of a business and production process, a determination of process steps, and an identification of process step requirements;
evaluating the response to the questionnaire via a second computer software application process tangibly embodied in a physical storage device executing on the physical computer hardware machine of the service provider according to graphical user interface requirements for each of a plurality of individual process steps consisting at least in part of machine parameters of temperature, pressure, run time, maintenance cycle, and clean cycle; product parameters of thickness, flatness, roughness, resistance, and hardness; and process parameters of statistical process control, specification data, and lead time;
defining a graphical user interface for each one of the plurality of individual process steps via a third computer software application process tangibly embodied in a physical storage device executing on the physical computer hardware machine of the service provider based on the evaluation of the response to the questionnaire;
providing via a fourth computer software application process tangibly embodied in a physical storage device executing on the physical computer hardware machine of the service provider the graphical user interface for each of the plurality of individual process steps to the client for installation on client computing devices in a manufacturing line of the client over the global network according to pre-existing graphical user interface templates identified by the service provider or new graphical user interface templates generated by the service provider;
receiving electronic data via the global network in real time by a fifth computer software application process tangibly embodied in a physical storage device executing on the physical computer hardware machine of the service provider collected via the graphical user interface for each of the plurality of individual process steps within the client manufacturing line, the data containing information at least in part relative to process and equipment conditions and identification, process and product material and operational data, and maintenance and time stamp information;
uploading the received electronic data via a sixth computer software application process tangibly embodied in a physical storage device executing on the physical computer hardware machine of the service provider into a data repository;
evaluating the uploaded electronic data via a seventh computer software application process tangibly embodied in a physical storage device executing on the physical computer hardware machine of the service provider for purposes of monitoring and controlling each of the plurality of individual process steps; and
generating real time reporting to the client via a eighth computer software application process tangibly embodied in a physical storage device executing on the physical computer hardware machine of the service provider based on the evaluation of the uploaded electronic data.
